(19) United States
(12) Patent Application Publication
(10) Pub. No.: US 2023/0306547 A1
(43) Pub. Date: Sep. 28, 2023

(54) DIGITAL CREDENTIAL DEPENDENCY MANAGEMENT

(71) Applicant: International Business Machines Corporation, Armonk, NY (US)

(72) Inventors: Milan Saumil Patel, Raleigh, NC (US); Bryce Allen Curtis, Round Rock, TX (US); Daniel Anthony Gisolfi, Hopewell, NY (US); Brian Keith Smith, Raleigh, NC (US); Aaron Keith Reed, Cary, NY (US)

(21) Appl. No.: 17/648,828

(22) Filed: Jan. 25, 2022

(51) Int. Cl. G06Q 50/26

(52) U.S. Cl. CPC G06Q 50/265

(57) ABSTRACT

Disclosed are techniques directed to digital credential dependency management. Metadata mappings are maintained between digital credentials, their underlying attributes, and dependent entities which verify and rely upon the digital credentials. When a digital credential is presented for proof to a verification entity, a dependency mapping is generated linking between the verification entity and the attributes that the verification entity requested for presentation. Updates to the digital credentials, or underlying attributes of the digital credentials, can trigger automatic notifications to the verification entities indicated in the dependency mapping. Automatic notifications, as well as their contents, may be defined by user settings to dictate which verification entities receive notifications and what digital credential and underlying attribute information is included in said notifications.

### BACKGROUND

The present invention relates generally to the field of digital user credential management, and more particularly to management of digital credentials and their inter-credential dependencies.

In the physical world, a credential may comprise: information corresponding to identifying the subject of the credential (for example, a photo, name, or identification number), information corresponding to the issuing authority (for example, a city government, national agency, or certification body), information corresponding to the type of credential this is (for example, a French passport, a Canadian driving license, or a health insurance card), information corresponding to specific attributes or properties being asserted by the issuing authority about the subject (for example, nationality, the classes of vehicle entitled to drive, or date of birth), evidence corresponding to how the credential was derived, information corresponding to constraints on the credential (for example, expiration date, or terms of use). A verifiable credential is capable of representing all of the same information that a physical credential represents. The addition of technologies, such as digital signatures, enhances verifiable credentials to be more tamper-evident and more trustworthy than their physical counterparts. Holders of verifiable credentials may generate verifiable presentations and then share these verifiable presentations with verifiers to establish that they possess verifiable credentials with certain characteristics. Both verifiable credentials and verifiable presentations can be communicated rapidly, making them more convenient than their physical counterparts when trying to establish trust at great distances.

Among individuals and organizations, many use globally unique identifiers in a wide variety of contexts. They function as communications addresses (telephone numbers, email addresses, usernames on social media), ID numbers (for passports, drivers licenses, tax IDs, health insurance), and product identifiers (serial numbers, barcodes, RFIDs). URIs (Uniform Resource Identifiers) are utilized for resources on the Web, and each web viewed in a browser has a globally unique URL (Uniform Resource Locator).

Decentralized identifiers (DIDs) are a type of identifier which enables verifiable, decentralized digital identity. A DID typically refers to any subject (e.g., an organization, person, thing, data model, abstract entity, etc.) as determined by the controller of the DID. In contrast to typical, federated identifiers, DIDs are designed so that they can be decoupled from centralized registries, identity providers, and certificate authorities. More specifically, while other parties can be used to help enable the discovery of information related to a DID, the design enables the controller of a DID to prove control over the DID without requiring permission from any other party. DIDs are URIs that associate a given DID subject with a given DID document, enabling trustable interactions associated with that subject. Each DID document may express cryptographic material, verification methods, or services, which provide a set of mechanisms providing a DID controller to prove control of the DID. Services can enable trusted interactions associated with the DID subject. A DID may serve as the means to return the DID subject itself, if the DID subject is an information resource such as a data model.

### SUMMARY

According to an aspect of the present invention, there is a method, computer program product and/or system that performs the following operations (not necessarily in the following order): (i) receiving a plurality of digital credentials corresponding to a user, where each digital credential of the plurality of digital credentials corresponds to a type of permission or qualification that the user possesses; (ii) receiving a proof response metadata set including information indicative of: (i) a plurality of verification transactions in which the user has engaged, and (ii) identities of digital credential(s) involved in each verification transaction of the plurality of verification transactions; (iii) generating a credential dependencies mapping data set including information indicative of a mapping between verification transactions and digital credentials; (iv) receiving an update to a first digital credential of the plurality of digital credentials; and (v) responsive to receipt of the update, outputting a notification based, at least in part, on the mapping of the credential dependencies mapping data set.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a block diagram showing a typical verifiable credential environment; and

FIG. 6 is a block diagram showing a digital credential management environment according to a second embodiment of the present invention.

### DETAILED DESCRIPTION

Some embodiments of the present invention are directed to techniques directed to digital credential dependency management. Metadata mappings are maintained between digital credentials, their underlying attributes, and dependent entities which verify and rely upon the digital credentials. When a digital credential is presented for proof to a verification entity, a dependency mapping is generated linking between the verification entity and the attributes that the verification entity requested for presentation. Updates to the digital credentials, or underlying attributes of the digital credentials, can trigger automatic notifications to the verification entities indicated in the dependency mapping. Automatic notifications, as well as their contents, may be defined by user settings to dictate which verification entities receive notifications and what digital credential and underlying attribute information is included in said notifications.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium (sometimes referred to as “machine readable storage medium”) can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer’s non-volatile storage and partially stored in a set of semiconductor switches in the computer’s volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

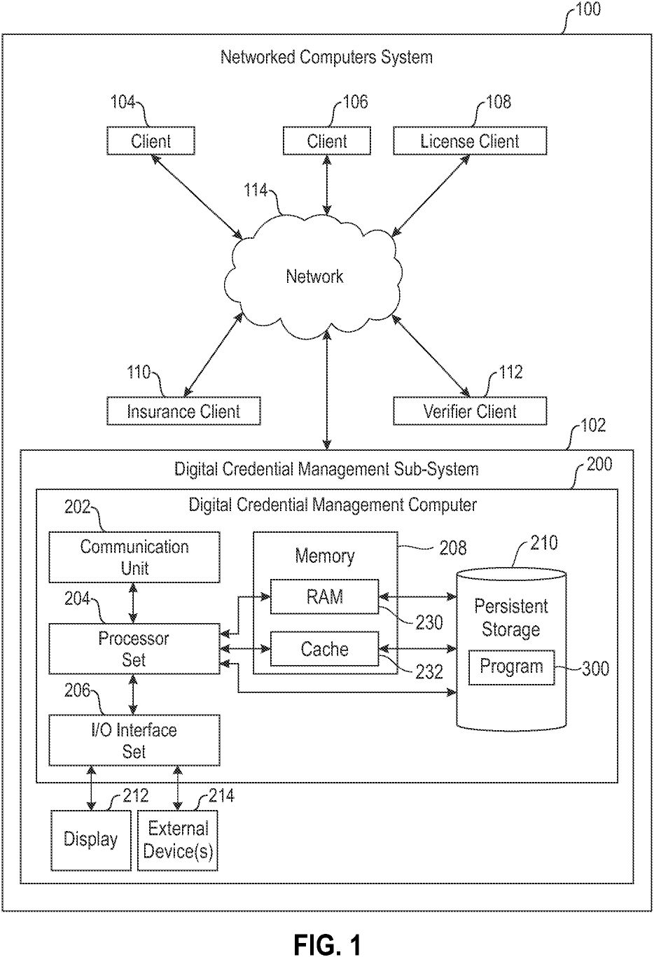

As shown in FIG. 1, networked computers system 100 is an embodiment of a hardware and software environment for use with various embodiments of the present invention, described in detail with reference to the Figures. Networked computers system 100 includes: digital credential management subsystem 102 (sometimes herein referred to, more simply, as subsystem 102); client subsystems 104, 106; license client subsystem 108; insurance client subsystem 110; verifier client 112; and communication network 114. Digital credential management subsystem 102 includes: digital credential management computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

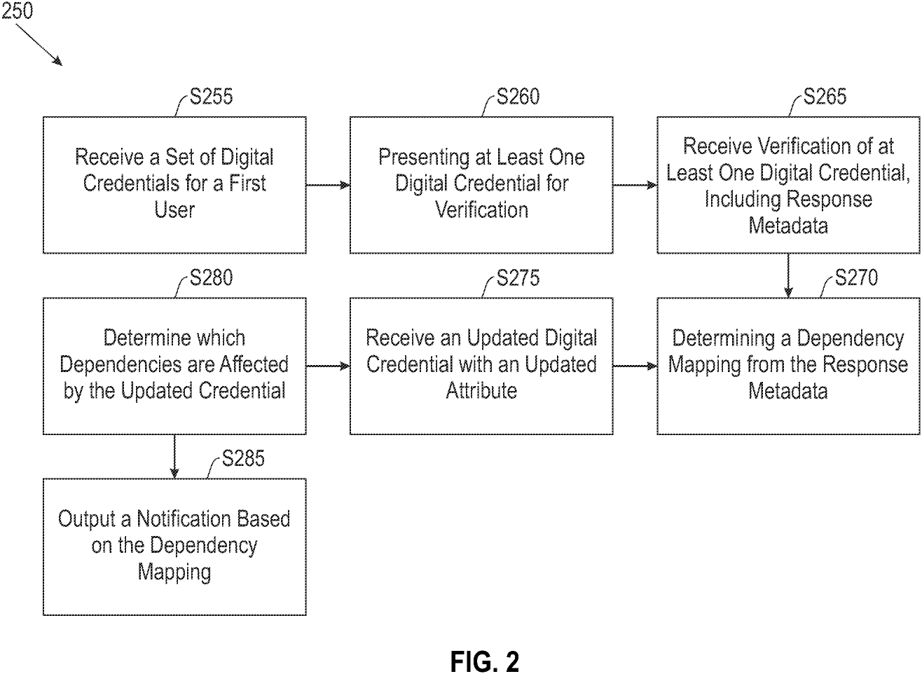

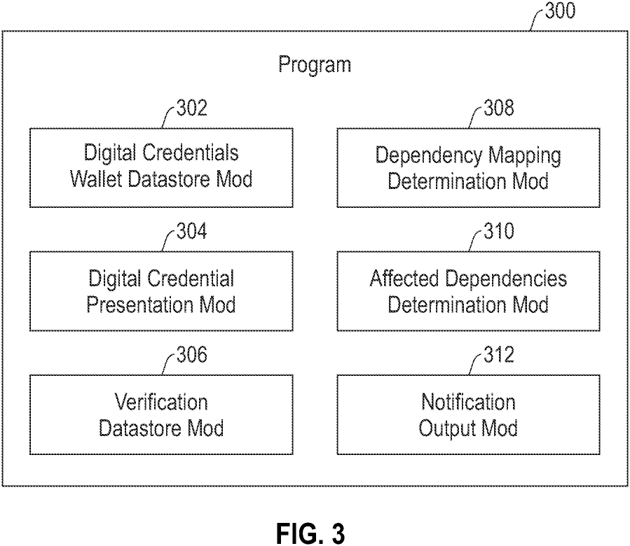

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Processing begins at operation S255, where digital credentials wallet datastore module (“mod”) 302 receive a set of digital credentials for a first user. In this simplified embodiment, a digital credential is a verifiable credential, and the set of digital credentials for the first user includes: (i) a driver’s license received from license client 108; and (ii) a proof of insurance card for a vehicle registered to the first user, received from insurance client 110. For the first user’s driver’s license, the digital credential includes: (i) the state of the license (New York); (ii) the name of the first user (Jane Doe); (iii) the date of birth of the first user (Jan. 1, 1989); (iv) residential address of the first user (123 Example Drive, Exampletown, New York); and (v) date of expiration of the driver’s license (Jan. 1, 2025). For the proof of insurance card, the corresponding digital credential includes: (i) the name of the first user (Jane Doe); (ii) the name of the insurer (Insurance Company); (iii) the policy number of the first user (54321); and (iv) the make and model of the insured vehicle (Reliable Sedan).

Processing proceeds to operation S260, where digital credential presentation mod 304 presents at least one digital credential for verification. In this simplified embodiment, the first user is attempting to reserve a rental car using the smartphone application of Acme Car Rentals, which is requesting presentation of a valid driver’s license and proof of insurance. More specifically, the following attributes are requested from the driver’s license: (i) name; (ii) date of birth; and (iii) date of expiration of driver’s license. Also, from the proof of insurance, the following attributes are requested: (i) name; and (ii) policy number. Digital credential presentation mod 304 presents the requested digital credentials in digital credentials wallet datastore mod 302 to the Acme Car Rentals smartphone app, which is relayed over network 114 to verifier client 112, which is a client computer which verifies credential presentations for the smartphone app of Acme Car Rentals.

Processing proceeds to operation S265, where verification datastore mod 306 receives verification of at least one digital credential, including response metadata. In this simplified embodiment, the verification is received from verifier client 112 and indicates accepted verification of both the driver’s license and proof of insurance of the first user. There are separate response metadata datasets for each presented credential, with each including: (i) credential presented; (ii) credential requester; and (iii) attributes presented. For the response metadata dataset corresponding to the driver’s license, the following values are received: (i) driver’s license; (ii) Acme Car Rentals smartphone app; (iii) name, date of birth, and date of expiration of driver’s license. For the response metadata dataset corresponding to the proof of insurance, the following values are received: (i) proof of insurance; (ii) Acme Car Rentals smartphone app; (iii) name, and policy number.

Processing proceeds to operation S270, where dependency mapping determination mod 308 determines a dependency mapping from the response metadata. In this simplified embodiment, a dependency mapping is a mapping between attributes of a digital credential and downstream entities requesting a digital credential attesting said attributes. Also in this simplified embodiment, a set of dependency mappings were previously determined between the driver’s license and the proof of insurance, where the insurance agency issuing the insurance policy (Insurance Company) and corresponding proof of insurance requested the digital credential of the driver’s license of the first user to verify the following attributes: (i) the state of the license (New York); (ii) the name of the first user (Jane Doe); (iii) the date of birth of the first user (Jan. 1, 1989); (iv) residential address of the first user (123 Example Drive, Exampletown, New York); and (v) date of expiration of the driver’s license (Jan. 1, 2025). A given digital credential may have one or more dependency mappings for each attribute of the given digital credential; each attribute may have separate dependency mappings based on which attributes were requested for credential verification operations. Some credential verifications may only request some of the attributes of a given digital credential, while others may be irrelevant to the present request. A given dependency mapping, in this simplified embodiment, includes the following fields: (i) digital credential attribute; and (ii) dependent entities. For example, in this simplified embodiment, with the previous dependency mappings described above, for the driver’s license digital credential, the dependency mappings for each of the following attributes presently only includes the Insurance Company proof of insurance dependent entity: (i) the state of the license (New York); (ii) the name of the first user (Jane Doe); (iii) the date of birth of the first user (Jan. 1, 1989); (iv) residential address of the first user (123 Example Drive, Exampletown, New York); and (v) date of expiration of the driver’s license (Jan. 1, 2025).

In some alternative embodiments, the dependency mapping may also include a notification setting, which controls what type of notifications are automatically sent in response to a changed digital credential attribute (for example, no automatic notification, a notification that the attribute is out of date, or a notification of the new attribute value). In further alternative embodiments, the notification setting includes values for each dependent entity of a given attribute, such that the notification setting for the given attribute may be differently configured by a user for each dependent entity. This notification setting may be set in response to user input indicating a desired notification setting. In yet further alternative embodiments, dependency mappings are generated for each dependent entity requesting the digital credential, with the dependency mapping a list of attributes that the dependent entity requested proof of in the form of the digital credential. In even further alternative embodiments, where dependency mappings are generated for each dependent entity requesting the digital credential, the dependency mappings further include individual notification settings for the attributes, with the notification settings specific to the dependent entity and attribute, providing granular control for notifications of specific attributes to specific dependent entities.

In this present operation, dependency mappings are determined: (i) between the Acme Car Rentals smartphone app and the requested attributes of the driver’s license; and (ii) between the Acme Car Rentals smartphone app and the requested attributes of the proof of insurance. From the metadata received by and stored in verification datastore mod 306, dependency mappings for the driver’s license and the Acme Car Rentals smartphone app are determined for the following attributes of the driver’s license: (i) name; (ii) date of birth; and (iii) date of expiration of driver’s license. The dependency mapping for the name attribute of the driver’s license is updated, now including the Acme Car Rentals smartphone app as a dependent entity in addition to the Insurance Company previously determined, now reading as follows: Insurance Company, Acme Car Rentals smartphone app. The dependency mapping for the date of birth attribute of the driver’s license is updated, now including the Acme Car Rentals smartphone app as a dependent entity in addition to the Insurance Company previously determined, now reading as follows: Insurance Company, Acme Car Rentals smartphone app. The dependency mapping for the date of expiration of the driver’s license attribute of the driver’s license is updated, now including the Acme Car Rentals smartphone app as a dependent entity in addition to the Insurance Company previously determined, now reading as follows: Insurance Company, Acme Car Rentals smartphone app.

Additionally, new dependency mappings are now determined for attributes of the proof of insurance, which had no prior dependency mappings. The dependent entity field of the dependency mappings of the name attribute of the proof of insurance now reads: Acme Car Rentals smartphone app. The dependent entity field of the dependency mappings of the policy number attribute of the proof of insurance now reads: Acme Car Rentals smartphone app.

Processing proceeds to operation S275, where digital credentials wallet datastore mod 302 receives an updated digital credential with an updated attribute. In this simplified embodiment, the updated digital credential is the driver’s license, received from license client 108, which has been updated with a new name. The name attribute of the driver’s license has changed from “Jane Doe” to “Jane Smith.”

Processing proceeds to operation S280, where affected dependencies determination mod 310 determines which dependencies are affected by the updated credential. In this simplified embodiment, affected dependencies determination mod 310 determines which dependencies are affected by the updated credential by analyzing the dependency mappings for the updated attribute(s) of the digital credential (the driver’s license) to determine dependent entities (if any) which are determined to be affected by the updated credential, limited to dependent entities listed in the dependent entities of the update attribute(s). For this simplified embodiment, the dependency mapping for the name attribute of the driver’s license for the first user includes the following dependent entities, which are determined to be affected by the updated driver’s license credential: (i) Insurance Company; and (ii) Acme Car Rentals smartphone app. In some alternative embodiment, when an updated digital credential is received with an updated attribute, dependent entities for attributes that were not changed in the updated credential are determined to be affected as a result of the digital credential itself being updated, rendering the previous version of the digital credential out of date.

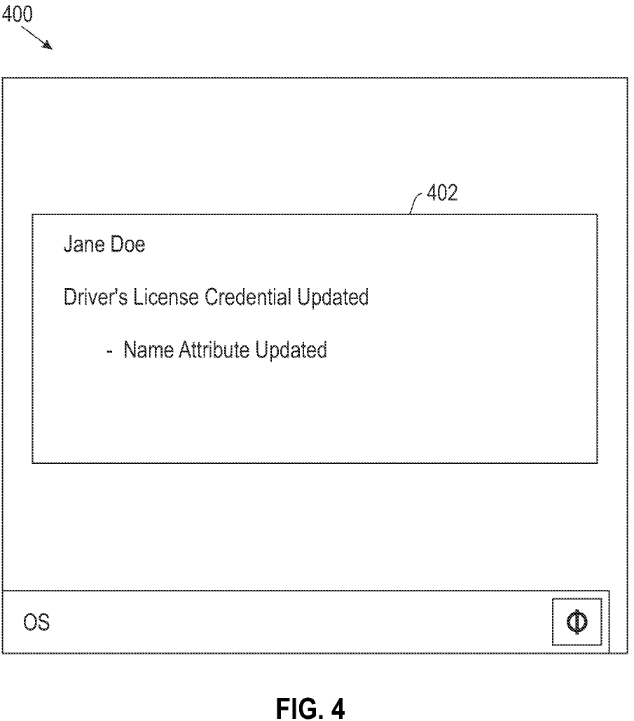

Processing proceeds to operation S285, where notification output mod 312 outputs a notification based on the dependency mapping. In this simplified embodiment, the notification is automatically sent to the dependent entities determined in S280, which includes: (i) Insurance Company; and (ii) Acme Car Rentals smartphone app. For Insurance Company, the notification is sent to insurance client 110. For Acme Car Rentals smartphone app, the notification is sent to verifier client 112. In this simplified embodiment, the notification is as shown in notification 402 of screenshot 400 of FIG. 4. This notification includes what credential was updated and what attribute was updated, but not what the updated attribute value (the new updated name) is for the updated attribute. In some alternative embodiments, the notification is the presentation of the updated credential attributes for verification and proof response. In further alternative embodiments, the contents of the notification for a given updated digital credential (or digital credential attribute) are tailored to individual dependent entities based on user-defined notification settings in the dependency mapping, providing granular controls for the user to define what notifications (if any) are automatically sent, who they are sent to, and what information is included in each notification. Some dependent entities may get automatic notifications showing the updated attribute, or simply that there was an update to the attribute, or no notification at all.

### III. Further Comments And/or Embodiments

Some embodiments of the present invention recognize the following facts, potential problems and/or potential areas for improvement with respect to the current state of the art: (i) one capability that is needed is for the holder to view the inter-dependencies between credentials; (ii) if upstream credential attributes are modified, downstream credential attributes dependent on those upstream credential attributes need to be easily identifiable; (iii) such that an holder managing their own sets of attributes can understand the dependencies; (iv) another shortcoming is that when an attribute of a credential changes, there is no way for the holder to notify or trigger any dependent credential issuers that specific attributes were updated; (v) there also does not exist a granular mechanism to allow the holder to select which issuers to automatically notify when any attribute changes; (vi) to address these issues, decentralized identity solutions could maintain references and links of all the credentials and attributes within the corpus of a digital wallet; (vii) such that any attribute change can trigger dependency notifications to the holder; (viii) the holder can then decide whether to notify the credential issuer of these changes; and (ix) the holder should also be able to view the inter-dependencies at any point in time to understand upstream and downstream attribute linkage.

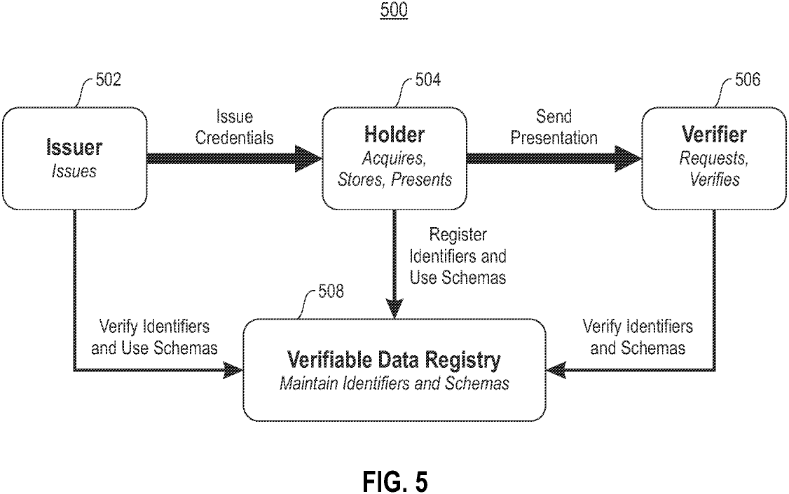

Shown in diagram 500 of FIG. 5 is a typical verifiable credential environment according to the state of the art, including: (i) issuer 502; (ii) holder 504; (iii) verifier 506; and (iv) verifiable data registry 508.

Some embodiments of the present invention may include one, or more, of the following operations, features, characteristics and/or advantages: (i) with the advent of newer technologies such as decentralized identity, individuals, as end users, will have more control over their identity, including their relationships and collection of meta data attributes; (ii) these relationships and meta data attributes will reside in a “digital” wallet owned by the individual; (iii) allowing for the explicit ownership and management, similar to how holders store and manage physical renderings of credentials in physical wallets and purses today; (iv) given the complex nature of types of digital credentials an individual can manage, there exist upstream and downstream sets of dependencies through the credential lifecycle chain; (v) holders may use credentials to obtain more credentials, creating an implicit dependency mapping between the credential and a relationship that may have verified the credential before issuing their own credential and/or updating their system of record; (vi) in the physical world when a driver’s license attribute changes such as an address or name, it has cascading downstream effects on credentials that were obtained by showing a driver’s license (such as health insurance cards, etc.); and (vii) any downstream credentials will need to be re-issued based on the attribute changes of dependency credentials.

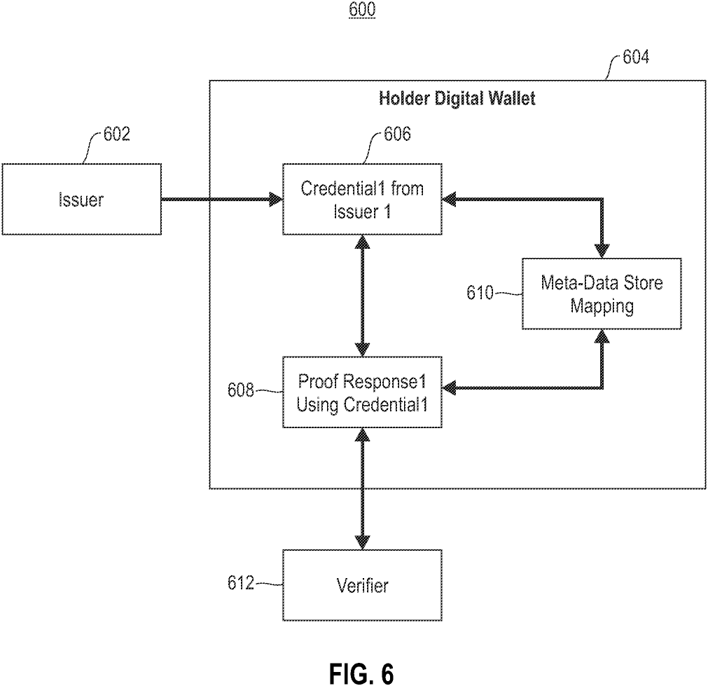

Some embodiments of the present invention may include one, or more, of the following operations, features, characteristics and/or advantages: (i) a data model linkage between the various credentials and their issuers within the corpus of a holders digital wallet; (ii) enable viewing and generating notifications from the holder to downstream verifiers that initially used the issued credentials as part of a proof request/response flow; (iii) each credential has a set of attributes within it; (iv) the credentials also indicate the issuer’s DID, verifier’s DID and corresponding metadata as part of the holder obtaining, storing, and presenting credentials; (v) an example issued credential along with the corresponding attributes and other details/aspects are discussed further below in reference to FIG. 6; (v) this can be referred to as Credential_1; (vi) the relevant details for Issued Credential Meta-data from Issuer to Holder include: (a) Connection ID, (b) Credential ID, (c) Credential definition ID, (d) Issuer ID, and (e) Attributes; (vii) pertinent details such as Issuer DID, attributes, and others are important to capture in a credential dependency meta-data store mapping; (viii) using this mapping, any update to a credential or attribute existing within the holder digital wallet will trigger the notification of attribute changes to the holder; (ix) the holder can then decide whether to notify the credential issuer of these changes; (x) as specified, Credential_1 can be used across various interactions; (xi) as shown in FIG. 6 (discussed further below), a user used Credential_1 along with another credential to establish trust within another organization (verifier); (xii) through a proof request fulfillment, there is meta-data that can be captured as part of the meta-data store mapping to determine which other credentials are impacted if a credential attribute changed; (xiii) below is an example of pertinent proof response metadata and the corresponding attributes that may be captured as part of the meta-data store mapping in the case when upstream credentials are updated and the holder wants to automatically trigger a request to a pertinent relationship such as another credential issuer; and (xiv) this can be called this Proof_Response_1.

Some embodiments of the present invention may include one, or more, of the following operations, features, characteristics and/or advantages: (i) details for Verified Credential Meta-data from Holder to Verifier include: (a) Proof response ID, (b) Issuer Credential definition ID, (c) Revealed Attributes, and (d) Verifier DID; (ii) with details of the credentials attributes used to fulfill a proof request with Proof_Response_1 and details of the proof request where those credential attributes were used, a meta-data store mapping can be created as it relates to creating a dependency mapping across the corpus of the holder’s digital wallet; (iii) meta data mapping of data attributes from Issuer to Holder and Holder to Verifier Mapping includes: (a) Connection ID, (b) Credential ID, (c) Credential definition ID, (d) Issuer ID, (e) Attributes, (f) Proof response ID, (g) Issuer Credential definition ID, (h) Revealed Attributes, and (j)Verifier DID; (iv) through this mapping definition, the holder’s digital identity wallet can maintain the dependency relationships with upstream credential attributes used with any downstream relationships; (v) this creates the baseline experiences of a holder being able to notify and visualize the various dependencies; (vi) the foundation of this can allow for the automatic trigger to any downstream relationships that are dependent on upstream credentials changes; (vii) the holder will have granularity in selecting which relationships to automatically notify as part of the user configuration; and (viii) this can also serve as the foundation for holders to visualize the dependency mapping through their digital wallet UI.

Some embodiments of the present invention may include one, or more, of the following operations, features, characteristics and/or advantages: (i) an example of this use case can be explained by considering a driver’s licenses experience; (ii) the driver’s license is a ubiquitous credential that attests to various attributes such as name, date of birth, address, and more; (iii) some attributes within that credential are static, such as date of birth, but others are transient and can be modified over the life of the holder, such as address and name; (iv) when these attributes change, a new driver’s license is issued to holders; (v) downstream relationships may need to be notified with these updated credential attributes; (vi) this can be financial institutions, healthcare institutions, and more; (vii) in a lot of cases, given the proliferation of relationships a holder accumulates, some relationships are an afterthought but still require data currency and validity; (viii) in the physical world, holders are required to remember the relationships that may be affected and notify them; (ix) in the digital world where there are similar experiences with credential and relationship dependencies, holders will need the ability for credential and relationship dependency mapping fully under the holder control; (x) this means the holder is the ultimate initiator and verifiers will not know of credential changes unless initiated by holders; and (xi) verifiers, however, can define business policy on how often holders are to re-present credentials to ensure accuracy.

Some embodiments of the present invention may include one, or more, of the following operations, features, characteristics and/or advantages: (i) the use of digital wallets that have embedded use of an emerging URI (identifier) that is a Decentralized Identifiers (DID) and the use of Verifiable Credentials data model; (ii) the wallet is in the hands of the user and not through a web interface; (iii) the wallet here can be on a mobile device through a mobile app or even on a smartwatch app, which makes this unique; (iv) specifically talking about digital wallets; (v) the ability to then allow for the re-issuance of having the mapping; (vi) not crawling anything, but mapping the contexts within a unique digital wallet; (vii) the user controls this experience; (viii) DIDs and Verifiable Credentials are a new data model to resolve and present digital based credentials between issuers, holders, and verifiers; (ix) notification and/or re-issuance of credentials while also creating a dependency graph; (x) providing more additional mediums of exchange and managing digital credentials, which is different than web user information; (xi) this includes mobile and smartwatch experiences; (xii) the ability to use those digital credentials in downstream interactions; (xiii) enabling the end user to use these credentials rather than just having a portrait view to market to the user; (xiv) here the user is in control of their credentials rather than being marketed to; (xv) the dependency graph is amongst the traits contained in the credentials, the credentials themselves and the parties issuing credentials based off of this data; and (xvi) all of the items in the graph pertain to a single user.

Some embodiments of the present invention are directed towards a first method for digital attributes and relationship dependency management comprising: (i) receiving a plurality of credentials with a plurality of attributes for a user from a plurality of credential issuers; (ii) analyzing the received plurality of credentials and the plurality of attributes to identify a dependencies mappings; and (iii) providing an interface to create, read, update, and delete (CRUD) entries in the dependencies mapping.

Some embodiments of the present invention are directed towards a second method for digital attributes and relationship dependency management, encompassing the first method above, wherein a digital wallet owned by the user links to a meta-data store containing the dependencies mapping.

Some embodiments of the present invention are directed towards a third method for digital attributes and relationship dependency management, encompassing the first and second methods above, wherein the meta-data store includes a Connection ID, a credential ID, a Credential definition ID, an Issuer ID, and Attributes.

Some embodiments of the present invention are directed towards a fourth method for digital attributes and relationship dependency management, encompassing the first, second and third methods above, wherein the meta-data store includes verified credential meta-data from holder to verifier [e.g., a Proof response ID, an Issuer Credential definition ID, a Revealed Attributes, and a Verifier DID].

Some embodiments of the present invention are directed towards a fifth method for digital attributes and relationship dependency management, encompassing the first, second, third and fourth methods above, wherein the meta-data store includes a data mapping of data attributes from Issuer to Holder and Holder to Verifier Mapping [e.g. a Connection ID, a Credential ID, a Credential definition ID, an Issuer ID, Attributes, a Proof response ID, an Issuer Credential definition ID, a Revealed Attributes, and Verifier DID].

Some embodiments of the present invention are directed towards a sixth method for digital attributes and relationship dependency management, encompassing the first, second, third, fourth, and fifth methods above, further comprising: (i) receiving an update to an attribute for the user; (ii) identifying dependencies associated with the update to the attribute; and (iii) providing a notification to the user of the identified dependencies.

Some embodiments of the present invention are directed towards a seventh method for digital attributes and relationship dependency management, encompassing the first, second, third, fourth, fifth and sixth methods above, further comprising: (i) providing support allowing the user to approve or deny the update and a selection of notifications of the identified dependencies.

Some embodiments of the present invention are directed towards a eighth method for digital attributes and relationship dependency management, encompassing the first, second, third, fourth, fifth, sixth and seventh methods above, further comprising: (i) responsive to receiving an approval of the update and the selection of notifications, processing the update and the selection of notifications.

Shown in diagram 600 of FIG. 6 is an example digital credential management environment according to a second embodiment of the present invention, including: (i) issuer 602; (ii) holder digital wallet 604; (iii) credentiall 606; (iv) proof response1 608; (v) meta-data store mapping 610; and (vi) verifier 612. In this example embodiment, credentiall 606 is issued to holder digital wallet 604 by issuer 602. When a user associated with holder digital wallet attempts to access a resource restricted by credential1, credentiall 606 is presented to verifier 612 for verification through proof response1 608. Meta-data store mapping 610 stores a meta-data link between credentiall and verifier 612, indicating a dependency mapping between the two, or a meta data mapping of data attributes from Issuer to Holder and Holder to Verifier Mapping. If an attribute of credentiall changes (for example, if the credential is a digital passport and the residential address of the user has changed), issuer 602 will issue an updated credentiall 606 to holder digital wallet 604. A search of meta-data mappings will be executed to check if there are any dependencies upon the changed attributes of credentiall to update any meta-data links, and, if configured, notifications will be automatically sent out to the verifiers corresponding to the dependencies. The updated credentiall is used to update proof response 1 608 in an updated credential presentment based on upstream credential changes (or, in this example the change to the user’s residential address in the digital passport).

Below is an example segment of pseudocode describing Issued Credential Meta-data from Issuer to Holder, such as those used in embodiments relating to FIG. 6:

{
“connection”: {
“id”: “aaaaaaaa-bbbb-cccc-dddd-eeeeeeeeeeee”,
“local”: {
“container_name”: “https://example.cloud”,
“iurl”: “https://example:@aaaaaaaaaaaaa.agent.cloud”,
“name”: “example”,
“pairwise”: {
“did”: “UUUUUUUUUUUUUUUUUUUUUU”,
“verkey”: “
UUUUUUUUUUUUUUUUUUUUUUUUUUUUUUUUUUUUUUUUUUUU ”
},
“properties”: {
“icon”: “”,
“time”: “2020-02-28T17:04:09.227Z”,
“type”: “child”
},
“public”: {
“did”: “DDDDDDDDDDDDDDDDDDDDDD”,
“verkey”:
“VVVVVVVVVVVVVVVVVVVVVVVVVVVVVVVVVVVVVVVVVV”
}, “role”: null,
“url”: “ https://example:@aaaaaaaaaaaaa.agent.cloud ”
},
“remote”: {
“container_name”:
“https://bbbbbbbbbbbbbbbbbbbbbbbb.cloud ”,
“iurl”:
“https://examplehr:@bbbbbbbbbbbbbbbbbbbbbbbb.cloud”,
“name”: “examplehr”,
“pairwise”: {
“did”: “PDDDDPDDDDDDDDDDDDDPDP”,
“verkey”:
“VVVVVVVVVVVVVVVVVVVVVVVVVVVVVVVVVVVVV1234567”
},
“properties”: {
“name”: “example1”,
“time”: “2020-02-28T17:04:00.290Z”,
“type”: “child”
},
“public”: {
“did”: “ DDDDDDDDDDDDDDDDDDDD12”,
“verkey”:
“VVVVVVVVVVVVVVVVVVVVVVVVVVVVVVVVVVVVV1234555”
},
“role”: “TRUST_ANCHOR”,
“url”: “
https://examplehr:@bbbbbbbbbbbbbbbbbbbbbbbb.cloud ”
},
“role”: “offeree”,
“state”: “connected”,
“state_connected_timestamp_secs”: 1582909450,
“state_inbound_offer_timestamp_secs”: 1582909444
},
“connection_did”: “CCCCCCCIDCCCCCCCCCCCCC”,
“cred_id”: “6f4151cd-042d-428f-953b-b0beeacc6c8f”,
“credential_definition_id”:
“V16FcuVb5wVajvYgyQHjjn:3:CL:79:TAG1”,
“id”: “121600166287”,
“issuer_did”: “ DDDDDDDDDDDDDDDDDDDD12”,
“offer”: {
“attributes”: {
“Base Salary”: “90000”,
“Company”: “Company”,
“Date of Birth”: “04-15-1982”,
“First Name”: “Name”,
“Hire Date”: “2/29/2016”,
“Job Title”: “Software Developer”,
“Last Name”: “LName”,
“Social Security Number”: “o0FAwXSz6V”,
“card_back”: “”,
“card_front”: “”,
“email”: “email@example.com”,
},
“data”:
“{\“schema_id\”:\“HqoxWsZg12Z3vQX6uZRAdz:2:Employment:1.1\”,\“cr
ed_def_id\”:\“HqoxWsZg12Z3vQX6uZRAdz:3:CL:42:TAG1\”,\“key_correc
tness_proof\”:{\“c\”:\“example details\”}”
},
“properties”: {
“icon”: “”,
“name”: “IBM HR”,
“time”: “2020-02-28T17:04:08.553Z”
},
“role”: “holder”,
“schema_id”: “HqoxWsZg12Z3vQX6uZRAdz:2:Employment:1.1”,
“schema_name”: “Employment”,
“schema_version”: “1.1”,
“state”: “stored”,
“state_inbound_offer_timestamp_secs”: 1582909452,
“state_stored_timestamp_secs”: 1582909457,
“to”: {
“did”: “ DDDDDDDDDDDDDDDDDDDDDD”
}
}

Below is an example segment of pseudocode describing Verified Credential Meta-data from Holder to Verifier, such as those used in embodiments relating to FIG. 6:

{
“connection”: {
“id”: “aaaaaaaa-aaaa-cccc-dddd-eeeeeeeeeeee”,
“local”: {
“container_name”: “https://example.cloud”,
“iurl”: “https://example:@aaaaaaaaaaaaa.agent.cloud”,
“name”: “example”,
“pairwise”: {
“did”: “UUUUUUUUUUUUUUUUUUUUUU”,
“verkey”: “
UUUUUUUUUUUUUUUUUUUUUUUUUUUUUUUUUUUUUUUUUUUU ”
},
“properties”: {
“icon”: “stuff”,
“name”: “Name”,
“time”: “2019-06-26T15:07:00.010Z”,
“type”: “child”
},
“public”: {
“did”: “DDDDDDDDDDDDDDDDDDDDDD”,
“verkey”:
“VVVVVVVVVVVVVVVVVVVVVVVVVVVVVVVVVVVVVVVVVVVV”
}
“role”: null,
“url”: “https://example:@aaaaaaaaaaaaa.agent.cloud ”
},
“remote”: {
“container_name”:
“https://bbbbbbbbbbbbbbbbbbbbbbbb.cloud ”,
“iurl”:
“https://examplehr:@bbbbbbbbbbbbbbbbbbbbbbbb.cloud”,
“name”: “examplehr”,
“pairwise”: {
“did”: “PDDDDPDDDDDDDDDDDDDPDP”,
“verkey”:
“VVVVVVVVVVVVVVVVVVVVVVVVVVVVVVVVVVVVV1234567”
},
“properties”: {
“name”: “example1”,
“time”: “2020-02-28T17:04:00.290Z”,
“type”: “child”
},
“public”: {
“did”: “DDDDDDDDDDDDDDDDDDDD13”,
“verkey”:
“VVVVVVVVVVVVVVVVVVVVVVVVVVVVVVVVVVVVV1234544”
},
“role”: “TRUST ANCHOR”,
“url”:
“https://examplecu:@bbbbbbbbbbbbbbbbbbbbbbbb.cloud ”
},
“role”: “offeree”,
“state”: “connected”,
“state_connected_timestamp_secs”: 1561561620,
“state_inbound_offer_timestamp_secs”: 1561561601
}
“id”: “013579906886”,
“info”: {
“attributes”: [
{
“cred_def_id”:
“3mX3d7VPQwq66k1paHgtdn:3:CL:77:TAG1”,
“name”: “address_line_1”,
“value”: “address1”
},
{
“cred_def_id”:
“3mX3d7VPQwq66k1paHgtdn:3:CL:77:TAG1”,
“name”: “address2”,
“value”: “_”
},
{
“cred_def_id”:
“3mX3d7VPQwq66k1paHgtdn:3:CL:77:TAG1”,
“name”: “country”,
“value”: “United States”
},
{
“cred_def_id”:
“3mX3d7VPQwq66k1paHgtdn:3:CL:77:TAG1”,
“name”: “dob”,
“value”: “date”
},
{
“cred_def_id”:
“3mX3d7VPQwq66k1paHgtdn:3:CL:77:TAG1”,
“name”: “first_name”,
“value”: “name”
},
{
“cred_def_id”
“3mX3d7VPQwq66k1paHgtdn:3:CL:77:TAG1”,
“name”: “last_name”,
“value”: “name”
},
{
“cred_def_id”:
“3mX3d7VPQwq66k1paHgtdn:3:CL:77:TAG1”,
“name”: “state”,
“value”: “state”
},
{
“cred_def_id”:
“3mX3d7VPQwq66k1paHgtdn:3:CL:77:TAG1”,
“name”: “zip_code”,
“value”: “zip”
},
{
“cred_def_id”:
“V16FcuVb5wVajvYgyQHjjn:3:CL:79:TAG1”,
“name”:“basesalary”,
“value”:“90000”
},
{
“cred_def_id”:
“V16FcuVb5wVajvYgyQHjjn:3:CL:79:TAG1”,
“name”: “company”,
“value”: “compnay”
},
{
“cred_def_id”:
“V16FcuVb5wVajvYgyQHjjn:3:CL:79:TAG1”,
“name”: “firstname”,
“value”: “name”
},
{
“cred_def_id”:
“V16FcuVb5wVajvYgyQHjjn:3:CL:79:TAG1”,
“name”: “lastname”,
“value”: “name”
},
{
“cred_def_id”:
“V16FcuVb5wVajvYgyQHjjn:3:CL:79:TAG1”,
“name”: “socialsecuritynumber”,
“value”: “number”
}
],
“predicates”: []
},
“proof”: {
“identifiers”: [
{
“cred_def_id”:
“3mX3d7VPQwq66k1paHgtdn:3:CL:77:TAG1”,
“rev_reg_id”: null,
“schema_id”: “3mX3d7VPQwq66k1paHgtdn:2:Gov DMV
Driver License:1.4”,
“timestamp”: null
},
{
“cred_def_id”:
“V16FcuVb5wVajvYgyQHjjn:3:CL:79:TAG1”,
“rev_reg_id”: null,
“schema_id”:
“V16FcuVb5wVajvYgyQHjjn:2:Employment:1.2”,
“timestamp”: null
}
],
“proof”: {
“aggregated_proof”: {
“c_hash”:
“730861221132814836893619054264977598199588516343165262698839685
03433171708898”,
“c_list”: [
“proofs”: [
{
“non_revoc_proof”: null,
“primary_proof”: {
“eq_proof”: {
“a_prime”:
},
“ge_proofs”: []
}
}
}
]
},
“requested_proof”: { “predicates”: {},
“revealed_attrs”: {
“Base Salary”: {
“encoded”: “90000”,
“raw”: “90000”,
“sub_proof_index”: 1 },
“Company”: {
“encoded”: “compnay”,
“raw”: “compnay”,
“sub_proof_index”: 1
},
“First Name”: {
“encoded”: “name”,
“raw”: “name”,
“sub_proof_index”: 1 },
“Last Name”: {
“encoded”: “name”,
“raw”: “name”,
“sub_proof_index”: 1
},
“Social Security Number”: {
“encoded”: “number”,
“raw”: “number”,
“sub_proof_index”: 1 },
“address_line_1”: {
“encoded”: “address”,
“raw”: “address”,
“sub_proof_index”: 0 },
“address_line_2”:{
“encoded”: “address”,
“raw”: “_”,
“sub_proof_index”: 0 },
“country”: {
“encoded”: “state”,
“raw”: “state”,
“sub_proof_index”: 0
},
“dob”: {
“encoded”: “date”,
“raw”: “date”,
“sub_proof_index”: 0 },
“first_name”: {
“encoded”: “name”,
“raw”: “name”,
“sub_proof_index”: 0 },
“last_name”: {
“encoded”: “name”,
“raw”: “name”,
“sub_proof_index”: 0
},
“state”: {
“encoded”: “state”,
“raw”: “state”,
“sub_proof_index”: 0 },
“zip_code”: {
“encoded”: “zip”,
“raw”: “zip”,
“sub_proof_index”: 0 }
},
“self_attested_attrs”: {},
“unrevealed_attrs”: {}
} },
“proof_display” : “display”,
“proof_request”: {
“id”: “Verify Employment:1.01579183903859”,
“name”: “Verify Employment”,
“nonce”: “013579906886”,
“requested_attributes”: {
“Base Salary”: {
“name”: “Base Salary”,
“restrictions”: [
{
“cred_def_id”:
“V16FcuVb5wVajvYgyQHjjn:3:CL:96:TAG1”
},
{
“cred_def_id”:
“V16FcuVb5wVajvYgyQHjjn:3:CL:294:TAG1”
},
{
“cred_def_id”:
“V16FcuVb5wVajvYgyQHjjn:3:CL:79:TAG1”
}
]
},
“Company”: {
“name”: “Company”,
“restrictions”: [
{
“cred_def_id”:
“V16FcuVb5wVajvYgyQHjjn:3:CL:96:TAG1”
},
{
“cred_def_id”:
“V16FcuVb5wVajvYgyQHjjn:3:CL:294:TAG1”
},
{
“cred_def_id”:
“V16FcuVb5wVajvYgyQHjjn:3:CL:79:TAG1”
} ]
},
“First Name”: {
“name”: “First Name”,
“restrictions”: [
{
“cred_def_id”:
“V16FcuVb5wVajvYgyQHjjn:3:CL:96:TAG1”
},
{
“cred_def_id”:
“V16FcuVb5wVajvYgyQHjjn:3:CL:294:TAG1”
},
{
“cred_def_id”:
“V16FcuVb5wVajvYgyQHjjn:3:CL:79:TAG1”
}
]
},
“Last Name”: {
“name”: “Last Name”,
“restrictions”: [
{
“cred_def_id”:
“V16FcuVb5wVajvYgyQHjjn:3:CL:96:TAG1”
},
{
“cred_def_id”:
“V16FcuVb5wVajvYgyQHjjn:3:CL:294:TAG1”
},
{
“cred_def_id”:
“V16FcuVb5wVajvYgyQHjjn:3:CL:79:TAG1”
}
]
},
“Social Security Number”: {
“name”: “Social Security Number”,
“restrictions”: [
{
“cred_def_id”:
“V16FcuVb5wVajvYgyQHjjn:3:CL:96:TAG1”
},
{
“cred_def_id”:
“V16FcuVb5wVajvYgyQHjjn:3:CL:294:TAG1”
},
{
“cred_def_id”:
“V16FcuVb5wVajvYgyQHjjn:3:CL:79:TAG1”
}
]
},
“address_line_1”: {
“name”: “address_line_1”,
“restrictions”: [
{
“cred_def_id”:
“3mX3d7VPQwq66k1paHgtdn:3:CL:92:TAG1”
},
{
“cred_def_id”:
“3mX3d7VPQwq66k1paHgtdn:3:CL:292:TAG1”
},
{
“cred_def_id”:
“3mX3d7VPQwq66k1paHgtdn:3:CL:77:TAG1”
}
]
},
“address_line_2”: {
“name”: “address_line_2”,
“restrictions”: [
{
“cred_def_id”:
“3mX3d7VPQwq66k1paHgtdn:3:CL:92:TAG1”
},
{
“cred_def_id”:
“3mX3d7VPQwq66k1paHgtdn:3:CL:292:TAG1”
},
{
“cred_def_id”:
“3mX3d7VPQwq66k1paHgtdn:3:CL:77:TAG1”
}
]
},
“country”: {
“name”: “country”,
“restrictions”: [
{
“cred_def_id”:
“3mX3d7VPQwq66k1paHgtdn:3:CL:92:TAG1”
},
{
“cred_def_id”:
“3mX3d7VPQwq66k1paHgtdn:3:CL:292:TAG1”
},
{
“cred_def_id”:
“3mX3d7VPQwq66k1paHgtdn:3:CL:77:TAG1”
}
]
},
“dob”: {
“name”: “dob”,
“restrictions”: [
{
“cred_def_id”:
“3mX3d7VPQwq66k1paHgtdn:3:CL:92:TAG1”
},
{
“cred_def_id”:
“3mX3d7VPQwq66k1paHgtdn:3:CL:292:TAG1”
},
{
“cred_def_id”:
“3mX3d7VPQwq66k1paHgtdn:3:CL:77:TAG1”
}
]
}
“first_name”: {
“name”: “first_name”,
“restrictions”: [
{
“cred_def_id”:
“3mX3d7VPQwq66k1paHgtdn:3:CL:92:TAG1”
},
{
“cred_def_id”:
“3mX3d7VPQwq66k1paHgtdn:3:CL:292:TAG1”
},
{
“cred_def_id”:
“3mX3d7VPQwq66k1paHgtdn:3:CL:77:TAG1”
}
]
},
“last_name”: {
“name”: “last_name”,
“restrictions”: [
{
“cred_def_id”:
“3mX3d7VPQwq66k1paHgtdn:3:CL:92:TAG1”
},
{
“cred_def_id”:
“3mX3d7VPQwq66k1paHgtdn:3:CL:292:TAG1”
},
{
“cred_def_id”:
“3mX3d7VPQwq66k1paHgtdn:3:CL:77:TAG1”
}
]
},
“state”: {
“name”: “state”,
“restrictions”: [
{
“cred_def_id”:
“3mX3d7VPQwq66k1paHgtdn:3:CL:92:TAG1”
},
{
“cred_def_id”:
“3mX3d7VPQwq66k1paHgtdn:3:CL:292:TAG1”
},
{
“cred_def_id”:
“3mX3d7VPQwq66k1paHgtdn:3:CL:77:TAG1”
}
]
},
“zip_code”: {
“name”: “zip_code”,
“restrictions”: [
{
“cred_def_id”:
“3mX3d7VPQwq66k1paHgtdn:3:CL:92:TAG1”
},
{
“cred_def_id”:
“3mX3d7VPQwq66k1paHgtdn:3:CL:292:TAG1”
},
{
“cred_def_id”:
“3mX3d7VPQwq66k1paHgtdn:3:CL:77:TAG1”
}
]
}, }
“requested_predicates”: {},
“version”: “1.01579183903859”
},
“proof_schema_id”: “Verify Employment:1.01579183903859”,
“proof_view”: {
“attributes”: [
{
“cred_def_id”:
“3mX3d7VPQwq66k1paHgtdn:3:CL:77:TAG1”,
“name”: “address_line_1”,
“value”: “address”
},
{
“cred_def_id”:
“3mX3d7VPQwq66k1paHgtdn:3:CL:77:TAG1”,
“name”: “address_line_2”,
“value”: “_” },
{
“cred_def_id”:
“3mX3d7VPQwq66k1paHgtdn:3:CL:77:TAG1”,
“name”: “country”,
“value”: “country”
}, {
“cred_def_id”:
“3mX3d7VPQwq66k1paHgtdn:3:CL:77:TAG1”,
“name”: “dob”,
“value”: “date”
},
{
“cred_def_id”:
“3mX3d7VPQwq66k1paHgtdn:3:CL:77:TAG1”,
“name”: “first_name”,
“value”: “name”
} ,
{
“cred_def_id”:
“3mX3d7VPQwq66k1paHgtdn:3:CL:77:TAG1”,
“name”: “last_name”,
“value”: “name”
},
{
“cred_def_id”:
“3mX3d7VPQwq66k1paHgtdn:3:CL:77:TAG1”,
“name”: “state”,
“value”:“state”
},
{
“cred_def_id”:
“3mX3d7VPQwq66k1paHgtdn:3:CL:77:TAG1”,
“name”: “zip_code”,
“value”: “zip” },
{
“cred_def_id”:
“V16FcuVb5wVajvYgyQHjjn:3:CL:79:TAG1”,
“name”: “basesalary”,
“value”: “90000”
},
{
“cred_def_id”:
“V16FcuVb5wVajvYgyQHjjn:3:CL:79:TAG1”,
“name”: “company”,
“value”: “compnay” },
{
“cred_def_id”:
“V16FcuVb5wVajvYgyQHjjn:3:CL:79:TAG1”,
“name”: “firstname”,
“value”: “name”
},
{
“cred_def_id”:
“V16FcuVb5wVajvYgyQHjjn:3:CL:79:TAG1”,
“name”: “lastname”,
“value”: “name”
},
{
“cred_def_id”:
“V16FcuVb5wVajvYgyQHjjn:3:CL:79:TAG1”,
“name”: “socialsecuritynumber”,
“value”: “number”
}
],
“predicates”: [] }
“properties”: {
“icon”: “icon”,
“name”: “Big Blue Credit Union”,
“time”: “2020-01-16T14:11:44.461Z”
},
“role”: “prover”,
“state”: “passed”,
“state_inbound_proof_request_timestamp_secs”: 1579183904,
“state_passed_timestamp_secs”: 1579183978,
“state_proof_generated_timestamp_secs”: 1579183972,
“state_proof_shared_timestamp_secs”: 1579183973,
“to”: {
“did”: “DDDDDDDDDDDDDDDDDDDDDD” }, “verifier_did”: “ DDDDDDDDDDDDDDDDDDDD13”, “type”: “verification” }

Below is an example segment of pseudocode describing Meta data mapping of data attributes from Issuer to Holder and Holder to Verifier Mapping, such as those used in embodiments relating to FIG. 6:

{
“mapping”: {
“meta_data_mapping_id”: “9184749fbhebfibhfgj”,
“Verifiers”: {
“proof_response_id”: “013579906886”,
“issuer_credential_definition_id”:
“V16FcuVb5wVajvYgyQHjjn:3:CL:79:TAG1”,
“attributes_verrified” {
“Base Salary”: “90000”,
“Company”: “Company”,
“First Name”: “Name”,
“Last Name”: “LName”,
“Social Security Number”: “o0FAwXSz6V”,
}
“verifier_did”: “ DDDDDDDDDDDDDDDDDDDD13”,
}
“Issuers”: {
“id”: “aaaaaaaa-bbbb-cccc-dddd-
eeeeeeeeeeee”,
“issuer_did”: “ DDDDDDDDDDDDDDDDDDDD12”,
“issuer_credential_id”: “6f4151cd-042d-428f-953b-
b0beeacc6c8f”,
“issuer_credential_definition_id”:
“V16FcuVb5wVajvYgyQHjjn:3:CL:79:TAG1”
“Attributes”
{
“Base Salary”: “90000”,
“Company”: “Company”,
“First Name”: “Name”,
“Last Name”: “LName”,
“Social Security Number”: “o0FAwXSz6V”, }
}
} }

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above - similar cautions apply to the term “embodiment.”

and/or: inclusive or; for example, A, B “and/or” C means that at least one of A or B or C is true and applicable.

In an Including / include / includes: unless otherwise explicitly noted, means “including but not necessarily limited to.”

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

We: this document may use the word “we,” and this should be generally be understood, in most instances, as a pronoun style usage representing “machine logic of a computer system,” or the like; for example, “we processed the data” should be understood, unless context indicates otherwise, as “machine logic of a computer system processed the data”; unless context affirmatively indicates otherwise, “we,” as used herein, is typically not a reference to any specific human individuals or, indeed, and human individuals at all (but rather a computer system).

What is claimed is:

1. A computer-implemented method (CIM) comprising:
receiving a receiving a digital wallet data structure including a plurality of digital accounts, with at least some of the digital accounts including a digital credential associated with the digital account;
for each given digital account of the plurality of digital accounts, receiving a user input, through a granular mechanism, that indicates which attributes of the given digital account will be automatically updated when a similar attribute of one of the other digital accounts is updated pursuant to a verification transaction;
receiving a proof response metadata set for a first digital account of the plurality of digital accounts including information indicative of an identity of a first updated attribute of the first digital account that has been updated by verification transactions; and
for each given digital account of the plurality of digital accounts other than the first digital response:
determining whether an attribute of the given digital account is sufficiently similar to the first updated attribute, and
selectively and automatically updating the sufficiently similar attribute of the given digital account only if the sufficiently similar attribute is indicated as being appropriate for automatic updates.

2-18. (canceled)

19. A computer program product (CPP) comprising:
a set of storage device(s); and
computer code stored collectively in the set of storage device(s), with the computer code including data and instructions to cause a processor(s) set to perform at least the following operations:
receiving a receiving a digital wallet data structure including a plurality of digital accounts, with at least some of the digital accounts including a digital credential associated with the digital account,
for each given digital account of the plurality of digital accounts, receiving a user input, through a granular mechanism, that indicates which attributes of the given digital account will be automatically updated when a similar attribute of one of the other digital accounts is updated pursuant to a verification transaction,
receiving a proof response metadata set for a first digital account of the plurality of digital accounts including information indicative of an identity of a first updated attribute of the first digital account that has been updated by verification transactions, and
for each given digital account of the plurality of digital accounts other than the first digital response:
determining whether an attribute of the given digital account is sufficiently similar to the first updated attribute, and
selectively and automatically updating the sufficiently similar attribute of the given digital account only if the sufficiently similar attribute is indicated as being appropriate for automatic updates.

20. A computer system (CS) comprising:
a processor(s) set;
a set of storage device(s); and
computer code stored collectively in the set of storage device(s), with the computer code including data and instructions to cause the processor(s) set to perform at least the following operations:
receiving a receiving a digital wallet data structure including a plurality of digital accounts, with at least some of the digital accounts including a digital credential associated with the digital account,
for each given digital account of the plurality of digital accounts, receiving a user input, through a granular mechanism, that indicates which attributes of the given digital account will be automatically updated when a similar attribute of one of the other digital accounts is updated pursuant to a verification transaction,
receiving a proof response metadata set for a first digital account of the plurality of digital accounts including information indicative of an identity of a first updated attribute of the first digital account that has been updated by verification transactions, and
for each given digital account of the plurality of digital accounts other than the first digital response:
determining whether an attribute of the given digital account is sufficiently similar to the first updated attribute, and
selectively and automatically updating the sufficiently similar attribute of the given digital account only if the sufficiently similar attribute is indicated as being appropriate for automatic updates.
